(19) United States
(12) Patent Application Publication
(10) Pub. No.: US 2016/0320944 A1
(43) Pub. Date: Nov. 3, 2016

(54) CHARACTER PROCESSING METHOD AND DEVICE

(71) Applicant: HUAWEI DEVICE CO., LTD., Shenzhen, Guangdong (CN)

(72) Inventors: Quancheng HAN, Shenzhen (CN); Wei WANG, Beijing (CN)

(21) Appl. No.: 15/108,524

(22) PCT Filed: Dec. 27, 2013
(86) PCT No.: PCT/CN2013/090714

§ 371 Date: Jun. 27, 2016

(51) Int. Cl. G06F 3/0481; G06F 3/01; G06F 3/0484; G06F 3/0482; G06F 3/0488

(52) U.S. Cl. CPC G06F 3/04817; G06F 3/0482; G06F 3/04883; G06F 3/04845; G06F 3/018

(57) ABSTRACT

The preset invention provides a character processing method and device. An instruction for copying a character selected by a user is received; an icon that is used to identify the character selected by the user is displayed on a screen of user equipment according to the instruction; an instruction of the user for moving the icon to an input position is received; and the character selected by the user is pasted to the input position according to the instruction of the user for moving the icon to the input position. In this way, it is implemented that a character selected and copied by a user is visible, resolving a problem that a copied character is invisible on a background clipboard.

### TECHNICAL FIELD

The present invention relates to the mobile terminal field, and in particular, to a character processing method and a device.

### BACKGROUND

Existing user equipment such as a mobile phone has increasingly powerful functions, and paste and copy functions are used more frequently in the mobile phone. In conventional paste and copy operations, after a user finishes copying a selected word, a paste operation is prompted only when the cursor appears at a paste position selected by the user. Operation experience is poor, and the user does not have a sense of control.

### SUMMARY

Embodiments of the preset invention provide a character processing method and a device, so as to resolve a problem of poor experience of a user in copying and pasting a character.

According to a first aspect, a character processing method is provided, where the method includes:

receiving an instruction for copying a character selected by a user;

displaying, on a screen of user equipment according to the instruction, an icon that is used to identify the character selected by the user;

receiving an instruction of the user for moving the icon to an input position; and

pasting, according to the instruction of the user for moving the icon to the input position, the character selected by the user to the input position.

With reference to the first aspect, in a first possible implementation manner of the first aspect, the displaying, on a screen of user equipment according to the instruction, an icon that is used to identify the character selected by the user includes:

displaying, on the screen of the user equipment in a translucent manner according to the instruction, the icon that is used to identify the character selected by the user.

With reference to the first aspect, or the first possible implementation manner of the first aspect, in a second possible implementation manner of the first aspect, the icon includes at least one character of the character selected by the user.

With reference to the first aspect, or the first possible implementation manner of the first aspect, or the second possible implementation manner of the first aspect, in a third possible implementation manner of the first aspect, before the pasting, according to the instruction of the user for moving the icon to the input position, the character selected by the user to the input position, the method further includes:

determining that an operation performed on the icon by the user is an operation of deleting the icon; and

deleting the icon.

With reference to the third possible implementation manner of the first aspect, in a fourth possible implementation manner of the first aspect, the determining that an operation performed on the icon by the user is an operation of deleting the icon includes:

determining that the operation performed on the icon by the user is that the user moves the icon to a predetermined position; or

determining that the operation performed on the icon by the user is a predefined gesture operation.

With reference to the first aspect, or the first possible implementation manner of the first aspect, or the second possible implementation manner of the first aspect, or the third possible implementation manner of the first aspect, or the fourth possible implementation manner of the first aspect, in a fifth possible implementation manner of the first aspect, the displaying, on a screen of user equipment according to the instruction, an icon that is used to identify the character selected by the user includes:

displaying, on the screen of the user equipment, multiple icons that respectively correspond to characters selected by the user multiple times; and

the pasting, according to the instruction of the user for moving the icon to the input position, the character selected by the user to the input position includes:

according to the instruction of the user for moving at least one icon of the multiple icons displayed on the screen of the user equipment, pasting a character corresponding to the at least one icon of the multiple icons to the input position at least one time.

With reference to the second possible implementation manner of the first aspect, or the third possible implementation manner of the first aspect, or the fourth possible implementation manner of the first aspect, or the fifth possible implementation manner of the first aspect, in a sixth possible implementation manner of the first aspect, before the pasting, according to the instruction of the user for moving the icon to the input position, the character selected by the user to the input position, the method further includes:

editing the at least one character of the icon according to an editing instruction of the user.

According to a second aspect, user equipment is provided, where the user equipment includes:

a first receiving unit, configured to receive an instruction for copying a character selected by a user;

a displaying unit, configured to display, on a screen of the user equipment according to the instruction, an icon that is used to identify the character selected by the user;

a second receiving unit, configured to receive an instruction of the user for moving the icon to an input position; and

a pasting unit, configured to paste, according to the instruction of the user for moving the icon to the input position, the character selected by the user to the input position.

With reference to the second aspect, in a first possible implementation manner of the second aspect, the displaying unit is specifically configured to:

display, on the screen of the user equipment in a transparent manner according to the instruction, the icon that is used to identify the character selected by the user.

With reference to the second aspect, or the first possible implementation manner of the second aspect, in a second possible implementation manner of the second aspect, the icon includes at least one character of the character selected by the user.

With reference to the second aspect, or the first possible implementation manner of the second aspect, or the second possible implementation manner of the second aspect, in a third possible implementation manner of the second aspect, the user equipment further includes a deleting unit, where the deleting unit is specifically configured to:

determine that an operation performed on the icon by the user is an operation of deleting the icon; and

delete the icon.

With reference to the third possible implementation manner of the second aspect, in a fourth possible implementation manner of the second aspect, that the deleting unit determines that the operation performed on the icon by the user is an operation of deleting the icon includes:

determining that the operation performed on the icon by the user is that the user moves the icon to a predetermined position; or

determining that the operation performed on the icon by the user is a predefined gesture operation.

With reference to the second aspect, or the first possible implementation manner of the second aspect, or the second possible implementation manner of the second aspect, or the third possible implementation manner of the second aspect, or the fourth possible implementation manner of the second aspect, in a fifth possible implementation manner of the second aspect, the displaying unit is specifically configured to:

display, on the screen of the user equipment, multiple icons that respectively correspond to characters selected by the user multiple times; and

the pasting unit is specifically configured to:

according to the instruction of the user for moving at least one icon of the multiple icons displayed on the screen of the user equipment, pasting a character corresponding to the at least one icon of the multiple icons to the input position at least one time.

With reference the second possible implementation manner of the second aspect, or the third possible implementation manner of the second aspect, or the fourth possible implementation manner of the second aspect, or the fifth possible implementation manner of the second aspect, in a sixth possible implementation manner of the second aspect, the user equipment further includes an editing unit, where the editing unit is specifically configured to:

edit the at least one character of the icon according to an editing instruction of the user.

The embodiments of the preset invention provide a character processing method. An instruction for copying a character selected by a user is received; an icon that is used to identify the character selected by the user is displayed on a screen of user equipment according to the instruction; an instruction of the user for moving the icon to an input position is received; and the character selected by the user is pasted to the input position according to the instruction of the user for moving the icon to the input position. In this way, it is implemented that a character selected and copied by a user is visible, alleviating a problem of poor user experience caused by invisibility of a copied character on a background clipboard.

### BRIEF DESCRIPTION OF DRAWINGS

To describe the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a flowchart of a character processing method according to an embodiment of the present invention;

FIG. 2 is a flowchart of a character processing method according to an embodiment of the present invention;

FIG. 3 is a schematic diagram of a character processing method according to an embodiment of the present invention;

FIG. 4 is a schematic diagram of a character processing method according to an embodiment of the present invention;

FIG. 5 is a structural diagram of user equipment according to an embodiment of the present invention; and

FIG. 6 is a structural diagram of user equipment according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

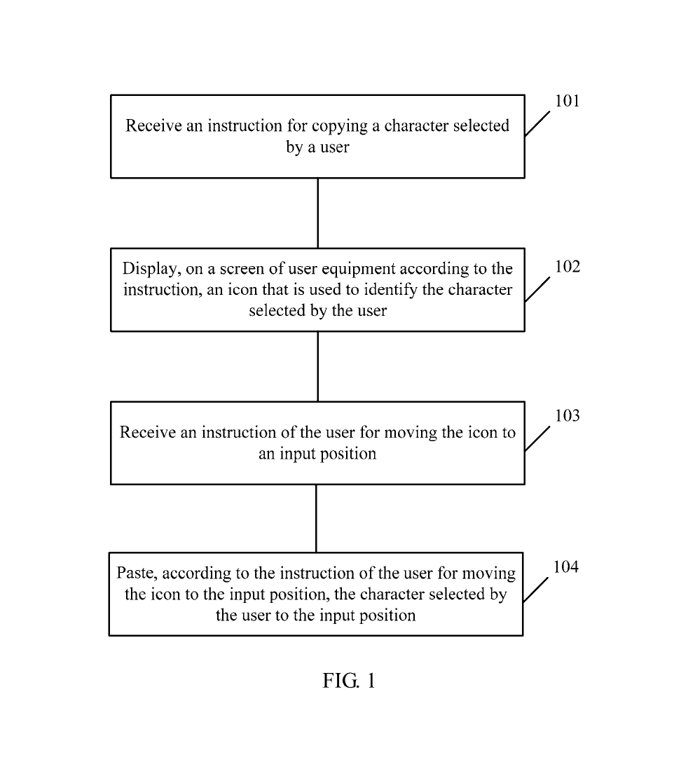

Referring to FIG. 1, FIG. 1 is a flowchart of a character processing method according to an embodiment of the present invention. As shown in FIG. 1, the method includes the following steps:

Step 101: Receive an instruction for copying a character selected by a user.

Step 102: Display, on a screen of user equipment according to the instruction, an icon that is used to identify the character selected by the user.

Optionally, the icon may be displayed in a predetermined position on the screen, or may be moved to a specified position according to movement of the user after the icon is displayed.

Optionally, the icon is always displayed in a frontmost position of the screen for user viewing.

Optionally, the displaying, on a screen of user equipment according to the instruction, an icon that is used to identify the character selected by the user includes:

displaying, on the screen of the user equipment in a transparent manner according to the instruction, the icon that is used to identify the character selected by the user.

Optionally, the icon includes at least one character of the character selected by the user, for example, the first character or all characters.

It should be noted that the transparent icon should make it convenient for the user to view the icon, and an input position to which the selected character is to be pasted, or another application under the icon. A person skilled in the art may understand that being “transparent” does not mean being totally transparent to such an extent that, for example, at least one character in the icon cannot be seen clearly, which obviously violates an original intention of the present invention.

Optionally, the transparent manner may be a translucent manner such as a transparency of 50%, or may be another transparent manner such as a transparency of 30% or 70%. Certainly, a transparency does not constitute any limitation, and the icon may not be displayed in a transparent manner.

Step 103: Receive an instruction of a user for moving the icon to an input position.

Step 104: Paste, according to the instruction of the user for moving the icon to the input position, the character selected by the user to the input position.

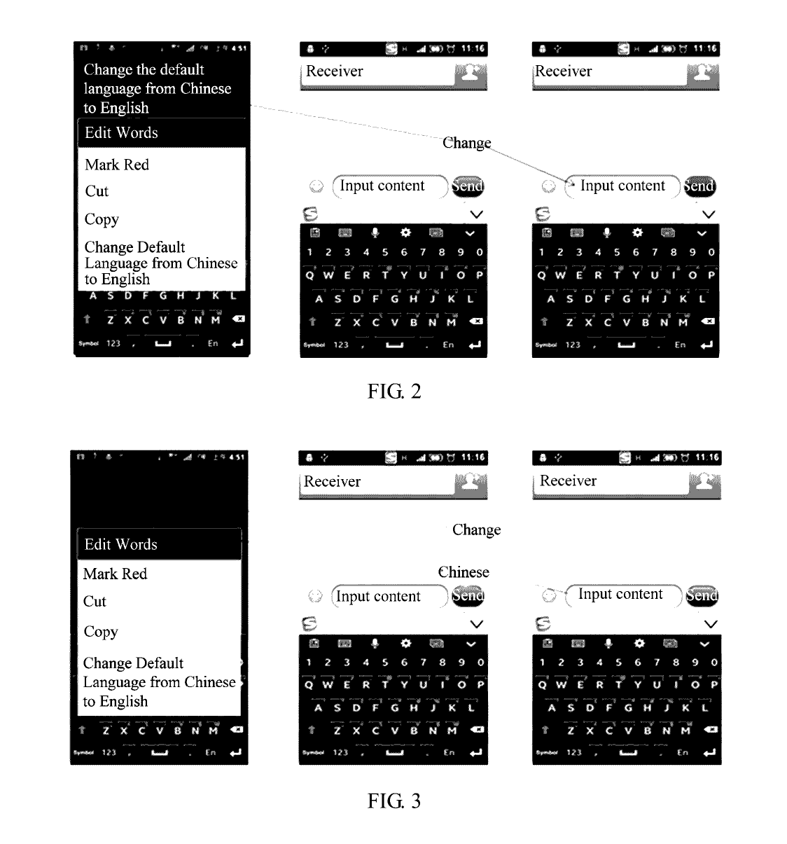

Specifically, referring to FIG. 2, FIG. 2 is a flowchart of a character processing method according to an embodiment of the present invention.

The user taps a character that needs to be selected, and selects Edit in a displayed setting box. For example, when the user taps characters “Change the default language from” that need to be selected, the character “Change” is displayed on the screen of the user equipment, and the other characters “the default language from” are hidden on a background clipboard. The foregoing method is only one of character displaying methods. “Change the default language from” may also be displayed on the screen of the user equipment.

The character “Change” may be displayed on the screen of the user equipment as a translucent icon. If a paste operation needs to be performed, the user may move the translucent icon to a cursor position in an input box, and after a short wait, the paste operation may be completed.

Optionally, the displaying, on a screen of user equipment according to the instruction, an icon that is used to identify the character selected by the user includes:

displaying, on the screen of the user equipment, multiple icons that respectively correspond to characters selected by the user multiple times; and

the pasting, according to the instruction of the user for moving the icon to the input position, the character selected by the user to the input position includes:

according to the instruction of the user for moving at least one icon of the multiple icons displayed on the screen of the user equipment, pasting a character corresponding to the at least one icon of the multiple icons to the input position at least one time.

Specifically, referring to FIG. 3, FIG. 3 is a schematic diagram of a character processing method according to an embodiment of the present invention. As shown in FIG. 3, characters selected by a user multiple times may be concurrently displayed on a screen of user equipment. For example, the user selects “Change the default language from” at the first time, and then “Change” shown in FIG. 3 is displayed in a translucent manner on the screen of the user equipment. The user selects “Chinese to English” at the second time, and then “Chinese” shown in FIG. 3 is displayed in a translucent manner on the screen of the user equipment. The user may select one translucent icon from the characters selected at the two times, and input the selected translucent icon to a cursor position in an input box along a movement track of the user on the screen. The user may select either of the two translucent icons displayed on the screen for input, or select the two for input, or may select the two icons for input at one time, and so on.

Optionally, before the pasting, according to the instruction of the user for moving the icon to the input position, the character selected by the user to the input position, the method further includes:

determining that an operation performed on the icon by the user is an operation of deleting the icon; and

deleting the icon.

Optionally, the determining that an operation performed on the icon by the user is an operation of deleting the icon includes:

determining that the operation performed on the icon by the user is that the user moves the icon to a predetermined position, for example, that the user moves the icon to a recycle bin on the screen; or

determining that the operation performed on the icon by the user is a predefined gesture operation, for example, the instruction triggered may be an instruction for triggering circle drawing, or an instruction for triggering wiping from side to side.

In this way, before the paste, the user may remove content not to be copied.

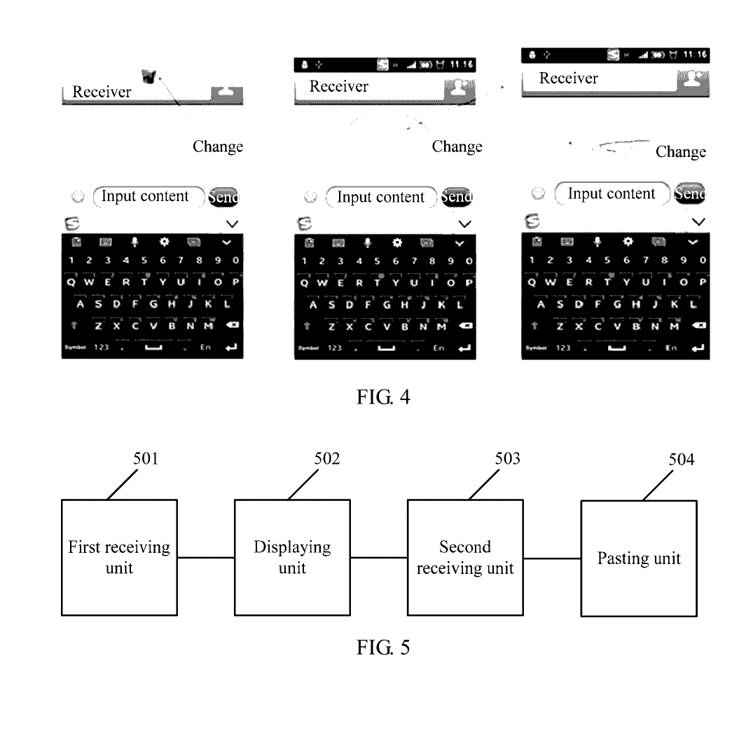

Specifically, referring to FIG. 4, FIG. 4 is a schematic diagram of a character processing method according to an embodiment of the present invention. As shown in FIG. 4, in a case in which a user needs to delete a translucent icon displayed on a screen, the user may directly drag the translucent icon to a recycle bin to perform deletion, or the user may draw a circle around a position of the translucent icon on the screen to perform deletion, or the user may wipe from side to side around the position of the translucent icon on the screen to perform deletion. The deletion instruction in the present invention is not limited to the foregoing three manners.

Optionally, before the pasting, according to the instruction of the user for moving the icon to the input position, the character selected by the user to the input position, the method further includes:

editing the at least one character of the icon according to an editing instruction of the user.

Specifically, if one or several characters of the character selected by the user need to be edited, the user may perform editing in the icon, and after the editing, drag the icon to the input position.

The embodiment of the preset invention provides a character processing method. An instruction for copying a character selected by a user is received; an icon that is used to identify the character selected by the user is displayed on a screen of user equipment according to the instruction; an instruction of the user for moving the icon to an input position is received; and the character selected by the user is pasted to the input position according to the instruction of the user for moving the icon to the input position. In this way, it is implemented that a character selected and copied by a user is visible, resolving a problem that a copied character is invisible on a background clipboard.

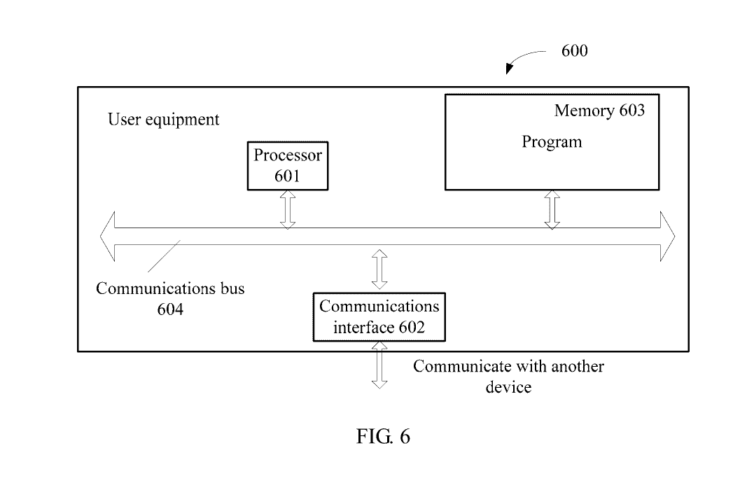

Referring FIG. 5, FIG. 5 is a structural diagram of user equipment according to an embodiment of the present invention. As shown in FIG. 5, the user equipment includes the following units: a first receiving unit 501, a displaying unit 502, a second receiving unit 503, and a pasting unit 504.

The first receiving unit 501 is configured to receive an instruction for copying a character selected by a user.

The displaying unit 502 is configured to display, on a screen of the user equipment according to the instruction, an icon that is used to identify the character selected by the user.

Optionally, the icon may be displayed in a predetermined position on the screen, or may be moved to a specified position according to movement of the user after the icon is displayed.

Optionally, the icon is always displayed on the front of the screen for user viewing.

Optionally, the displaying unit 502 is specifically configured to:

display, on the screen of the user equipment in a transparent manner according to the instruction, the icon that is used to identify the character selected by the user.

Optionally, the icon includes at least one character of the character selected by the user, for example, the first character or all characters.

It should be noted that the transparent icon should make it convenient for the user to view the icon, and an input position to which the selected character is to be pasted, or another application under the icon. A person skilled in the art may understand that “transparent” does not mean absolute transparency. For example, at least one character in the icon cannot be seen clearly, which obviously violates an original intention of the present invention.

Optionally, the transparent manner may be a translucent manner such as a transparency of 50%, or may be another transparent manner such as a transparency of 30% or 70%. Certainly, a transparency does not constitute any limitation, and the icon may not be displayed in a transparent manner.

The second receiving unit 503 is configured to receive an instruction of the user for moving the icon to an input position.

The pasting unit 504 is configured to paste, according to the instruction of the user for moving the icon to the input position, the character selected by the user to the input position.

Specifically, reference may be made to descriptions about FIG. 2. The user taps a character that needs to be selected, and selects Edit in a displayed setting box. For example, when the user taps characters “Change the default language from” that need to be selected, the character “Change” is displayed on the screen of the user equipment, and the other characters “the default language from” are hidden on a background clipboard. The foregoing method is only one of character displaying methods. “Change the default language from” may also be concurrently displayed on the screen of the user equipment.

The character “Change” may be displayed on the screen of the user equipment as a translucent icon. If a paste operation needs to be performed, the user may move the translucent icon to a cursor position in an input box, and after a short wait, the paste operation may be completed.

Optionally, the displaying unit 502 is specifically configured to:

display, on the screen of the user equipment, multiple icons that respectively correspond to characters selected by the user multiple times; and

the pasting unit 504 is specifically configured to:

move, according to the user, at least one icon of the multiple icons displayed on the screen of the user equipment, and paste a character corresponding to the at least one icon of the multiple icons to the input position at least one time.

Specifically, referring to descriptions about FIG. 3, characters selected by the user multiple times may be concurrently displayed on the screen of the user equipment. For example, the user selects “Change the default language from” at the first time, and then “Change” shown in FIG. 3 is displayed in a translucent manner on the screen of the user equipment. The user selects “Chinese to English” at the second time, and then “Chinese” shown in FIG. 3 is displayed in a translucent manner on the screen of the user equipment. The user may select one translucent icon from the characters selected at the two times, and input the selected translucent icon to a cursor position in the input box along a movement track of the user on the screen. The user may select either of the two translucent icons displayed on the screen for input, or select the two for input, or may select the two icons for input at one time, and so on. Optionally, the user equipment may further include a deleting unit, where the deleting unit is specifically configured to:

determine that an operation performed on the icon by the user is an operation of deleting the icon; and

delete the icon.

Optionally, that the deleting unit determines that the operation performed on the icon by the user is an operation of deleting the icon includes:

determining that the operation performed on the icon by the user is that the user moves the icon to a predetermined position, for example, that the user moves the icon to a recycle bin on the screen; or

determining that the operation performed on the icon by the user is a predefined gesture operation, for example, an instruction triggered may be an instruction for triggering circle drawing, or an instruction for triggering wiping from side to side.

In this way, before the paste, the user may remove content not to be copied.

Specifically, referring to FIG. 4, in a case in which the user needs to delete a translucent icon displayed on the screen, the user may directly drag the translucent icon to the recycle bin to perform deletion, or the user may draw a circle around a position of the translucent icon on the screen to perform deletion, or the user may perform wiping from side to side around the position of the translucent icon on the screen to perform deletion. The deletion instruction in the present invention is not limited to the foregoing three manners.

Optionally, the user equipment may further include an editing unit, where the editing unit is specifically configured to:

edit the at least one character of the icon according to an editing instruction of the user.

Specifically, if one or several characters of the character selected by the user need to be edited, the user may perform editing in the icon, and after the editing, drag the icon to the input position.

The embodiment of the preset invention provides user equipment. An instruction for copying a character selected by a user is received; an icon that is used to identify the character selected by the user is displayed on a screen of the user equipment according to the instruction; an instruction of the user for moving the icon to an input position is received; and the character selected by the user is pasted to the input position according to the instruction of the user for moving the icon to the input position. In this way, it is implemented that a character selected and copied by a user is visible, resolving a problem that a copied character is invisible on a background clipboard.

FIG. 6 is a structural diagram of user equipment according to an embodiment of the present invention. Referring to FIG. 6, FIG. 6 is the user equipment 600 provided in the embodiment of the present invention. The specific embodiment of the present invention does not limit specific implementation of the user equipment 600. The user equipment 600 includes:

a processor (processor) 601, a communications interface (Communications Interface) 602, a memory (memory) 603, and a bus 604.

The processor 601, the communications interface 602, and the memory 603 implement communication with each other by using the bus 604.

The communications interface 602 is configured to communicate with another device.

The processor 601 is configured to execute a program.

Specifically, the program may include program code, where the program code includes a computer operation instruction.

The processor 601 may be a central processing unit (central processing unit, CPU), or an application-specific integrated circuit ASIC (Application Specific Integrated Circuit), or one or more integrated circuits configured to implement the embodiments of the present invention.

The memory 603 is configured to store the program. The memory 603 may be a volatile memory (volatile memory), such as a random access memory (random-access memory, RAM), or a non-volatile memory (non-volatile memory), such as a read-only memory (read-only memory, ROM), a flash memory (flash memory), a hard disk drive (hard disk drive, HDD), or a solid state disk (solid-state drive, SSD). The processor 601 executes the following method according to the program instruction stored in the memory 603:

receiving an instruction for copying a character selected by a user;

displaying, on a screen of the user equipment according to the instruction, an icon that is used to identify the character selected by the user;

receiving an instruction of the user for moving the icon to an input position; and

pasting, according to the instruction of the user for moving the icon to the input position, the character selected by the user to the input position.

Optionally, the displaying, on a screen of the user equipment according to the instruction, an icon that is used to identify the character selected by the user includes:

displaying, on the screen of the user equipment in a translucent manner according to the instruction, the icon that is used to identify the character selected by the user.

Optionally, the icon includes at least one character of the character selected by the user.

Optionally, before the pasting, according to the instruction of the user for moving the icon to the input position, the character selected by the user to the input position, the method further includes:

determining that an operation performed on the icon by the user is an operation of deleting the icon; and

deleting the icon.

Optionally, the determining that an operation performed on the icon by the user is an operation of deleting the icon includes:

determining that the operation performed on the icon by the user is that the user moves the icon to a predetermined position; or

determining that the operation performed on the icon by the user is a predefined gesture operation.

Optionally, the displaying, on a screen of the user equipment according to the instruction, an icon that is used to identify the character selected by the user includes:

displaying, on the screen of the user equipment, multiple icons that respectively correspond to characters selected by the user multiple times; and

the pasting, according to the instruction of the user for moving the icon to the input position, the character selected by the user to the input position includes:

according to the instruction of the user for moving at least one icon of the multiple icons displayed on the screen of the user equipment, pasting a character corresponding to the at least one icon of the multiple icons to the input position at least one time.

Optionally, before the pasting, according to the instruction of the user for moving the icon to the input position, the character selected by the user to the input position, the method further includes:

editing the at least one character of the icon according to an editing instruction of the user.

Descriptions about similar steps, or terminologies, or principles in all embodiments of the present invention have much in common and may be referenced mutually to help understanding of each embodiment of the present invention.

The embodiment of the preset invention provides user equipment. An instruction for copying a character selected by a user is received; an icon that is used to identify the character selected by the user is displayed on a screen of the user equipment according to the instruction; an instruction of the user for moving the icon to an input position is received; and the character selected by the user is pasted to the input position according to the instruction of the user for moving the icon to the input position. In this way, it is implemented that a character selected and copied by a user is visible, resolving a problem that a copied character is invisible on a background clipboard.

The foregoing descriptions are merely exemplary implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A character processing method, implemented by a device, wherein the method comprises:
receiving an instruction for copying a character selected by a user;
displaying, on a screen of the device in a transparent manner according to the instruction, the icon that is used to identify the character selected by the user;
receiving an instruction of the user for moving the icon to an input position; and
pasting, according to the instruction of the user for moving the icon to the input position, the character selected by the user to the input position.

2. (canceled)

3. The method according to claim 1, wherein
the icon comprises one or more characters selected by the user.

4. The method according to claim 3, wherein before the pasting, according to the instruction of the user for moving the icon to the input position, the character selected by the user to the input position, the method further comprises:
determining that an operation performed on the icon by the user is an operation of deleting the icon; and
deleting the icon.

5. The method according to claim 4, wherein the determining that an operation performed on the icon by the user is an operation of deleting the icon comprises:
determining that the operation performed on the icon by the user is that the user moves the icon to a predetermined position; or
determining that the operation performed on the icon by the user is a predefined gesture operation.

6. The method according to claim 1, wherein the displaying, on a screen of the device in a transparent manner according to the instruction, the icon that is used to identify the character selected by the user, specially comprises:
displaying, on the screen of the device, multiple icons that respectively correspond to characters selected by the user multiple times; and
the pasting, according to the instruction of the user for moving the icon to the input position, the character selected by the user to the input position comprises:
according to the instruction of the user for moving at least one icon of the multiple icons displayed on the screen of the device, pasting a character corresponding to the at least one icon of the multiple icons to the input position at least one time.

7. The method according to claim 6, wherein before the pasting, according to the instruction of the user for moving the icon to the input position, the character selected by the user to the input position, the method further comprises:
editing the at least one character corresponding to the icon according to an editing instruction of the user.

8. A device for implementing a character processing method, wherein the device comprises:
a first receiving unit, configured to receive an instruction for copying a character selected by a user;
a displaying unit, configured to display, on a screen of the device according to the instruction, an icon that is used to identify the character selected by the user;
a second receiving unit, configured to receive an instruction of the user for moving the icon to an input position; and
a pasting unit, configured to paste, according to the instruction of the user for moving the icon to the input position, the character selected by the user to the input position.

9. The device according to claim 8, wherein the displaying unit is specifically configured to:
display, on the screen of the device in a transparent manner according to the instruction, the icon that is used to identify the character selected by the user.

10. The device according to claim 9, wherein the icon comprises one or more characters selected by the user.

11. The device according to claim 10, wherein the device further comprises a deleting unit, and the deleting unit is specifically configured to:
determine that an operation performed on the icon by the user is an operation of deleting the icon; and
delete the icon.

12. The device according to claim 11, wherein the deleting unit is specifically configured to:
determine that the operation performed on the icon by the user is that the user moves the icon to a predetermined position; or
determine that the operation performed on the icon by the user is a predefined gesture operation.

13. The device according to claim 12, wherein the displaying unit is specifically configured to:
display, on the screen of the device, multiple icons that respectively correspond to characters selected by the user multiple times; and
the pasting unit is specifically configured to:
move, according to the instruction of the user for moving, at least one icon of the multiple icons displayed on the screen of the device, and paste a character corresponding to the at least one icon of the multiple icons to the input position at least one time.

14. The device according to claim 13, wherein the device further comprises an editing unit, and the editing unit is specifically configured to:
edit the at least one character of the icon according to an editing instruction of the user.
